(19) United States
(12) Patent Application Publication
(10) Pub. No.: US 2016/0090771 A1
(43) Pub. Date: Mar. 31, 2016

(54) Cylinder Type Door Operator

(71) Applicant: CHUNG-HSIEN HSIEH, New Taipei City (TW)

(72) Inventor: Chung-Hsien Hsieh, New Taipei City (TW)

(21) Appl. No.: 14/827,527

(22) Filed: Aug. 17, 2015

(30) Foreign Application Priority Data
Sep. 25, 2014 (TW) 103133142

(51) Int. Cl. E05F 15/603; E05F 3/16; E05F 7/00; E05F 1/02; E05F 15/632; E05F 15/70

(52) U.S. Cl. CPC E05F 15/603; E05F 15/632; E05F 15/70; E05F 7/00; E05F 1/025; E05F 3/16

(57) ABSTRACT

A cylinder type door operator is provided. The door operator is disposed in a hollow winding shaft pivotally provided in a winding shaft box for moving a movable barrier. The door operator comprises: a tubular housing, an electric motor, an output shaft, an electromagnetic brake, and a centrifugal brake. The electric motor is accommodated in the tubular housing. The tubular housing has one end inserted into the winding shaft and the other end secured to the winding shaft box. The output shaft has one end coupled to the drive shaft and the other end protruded out of the tubular housing and secured to the winding shaft. The electromagnetic brake is provided for braking the drive shaft. The centrifugal brake is provided for limiting the rotational speed of the drive shaft.

### BACKGROUND OF THE INVENTION

1. Field of the Invention

The present invention relates to a cylinder type door operator and particularly to a door operator integrated into a winding shaft.

2. Description of the Related Art

A door operator generally used for, for example, upward, downward, horizontal or lateral movement of a movable barrier is typically arranged out of a winding shaft box in a direction parallel to a winding shaft, and the door operator is coupled to the winding shaft through a plurality of coupling mechanisms and transmission members. Therefore, the conventional door operator has a large volume and a complicated structure. Installation and operation of the conventional door operator are inconvenient, and the conventional door operator occupies an additional, considerable space.

To reduce the volume of the door operator, many related documents describing a cylinder type door operator integrated into a winding shaft are proposed. Taiwanese utility model patent Nos. TW M389160 and TW M385595 disclose an improved door operator comprising: a rotatable outer tube (main shaft); a power unit received in the outer tube at one end of the outer tube; a rotary shaft sleeve provided on the other end of the outer tube; a transmission shaft having one end pivotally fitted into the rotary shaft sleeve and the other end coupled to the rotary shaft of the power unit; and a preloaded spring fitted on the transmission shaft for providing a preloaded torque. A clutch and brake mechanism comprising a gear and a sleeve gear which are paired and engaged with each other is provided between the rotary shaft of the power unit and the transmission shaft. The gear and the sleeve gear can be disengaged from each other by pulling a steel wire such that a movable barrier can be manually moved upward or downward upon a power failure. These Taiwanese utility model patents provide the disclosure, that a general door operator is integrated into a winding shaft, but the mechanism as disclosed by Taiwanese utility model patents includes various parts and hence is complicated.

U.S. Pat. No. 7,275,631B2 issued to the present applicant discloses a door operator for a fire-proof door which is so designed that an electromagnet is electrically energized to attract a brake disc with a magnetic force so as to brake a rotary shaft of an electric motor when the electric motor is electrically de-energized; the electromagnet is electrically de-energized and the brake disc is biased away from the electromagnet by an elastic element for releasing the rotary shaft of the electric motor when the electric motor is electrically energized; and the rotary shaft of the electric motor is released and then the movable barrier is downward unwound due to the weight of the movable barrier so as to shut the door when a power failure, for example, interruption of power supply caused by an accident, occurs.

Bearing the problems and deficiencies of the prior art in mind, the present inventor conceives that the mechanism of a door operator for a fire-proof door can be modularized and integrated into a winding shaft and hence proposes a compact door operator in which coupling mechanisms and transmission members of the door operator to the winding shaft are simplified. With aid of the inventive door operator, the space necessary for installing the door operator can be greatly reduced, and the installation and operation of the door operator can be simplified. Accordingly, the reliability of the door operator is improved while the maintenance cost thereof is reduced.

### SUMMARY OF THE INVENTION

A main object of the present invention is to provide a cylinder type door operator integrated into a hollow winding shaft. As compared with the conventional door operator, the coupling mechanisms and the transmission members of the door operator to the winding shaft can be simplified such that a compact door operator is realized.

Another object of the present invention is to provide a cylinder type door operator which is integrated into a hollow winding shaft and is capable of reducing the space necessary for installing the door operator, simplifying the installation and operation of the door operator, improving the reliability of the door operator and saving the maintenance cost.

Still another object of the present invention is to provide a cylinder type door operator which is integrated into a hollow winding shaft and is so designed that a drive shaft of an electric motor is released by electrically de-energizing an electromagnet when the electric motor is electrically energized, and the drive shaft is braked when the electric motor is electrically de-energized. In the case that the door operator is intended to be used as a door operator for a fire-proof or smoke-proof door, the door operator can be further designed such that a movable barrier is moved automatically so as to shut the door when a power failure occurs.

To achieve the above-mentioned objects, a cylinder type door operator according to the present invention is provided. The door operator is disposed within a hollow winding shaft which is pivotally provided in a winding shaft box for moving a movable barrier. Preferably, the movable barrier is so arranged that a potential energy for urging the movable barrier to shut the door is stored or increased while the movable barrier is moved to open the door. The door operator comprises: a tubular housing having an internal space, the tubular housing comprising a first end inserted into the winding shaft and a second end secured to the winding shaft box; an electric motor accommodated in the internal space of the tubular housing, the electric motor comprising a drive shaft having a first end and a second end; an output shaft, one end of which is coupled to the first end of the drive shaft and the other end of which is protruded out of the tubular housing and provided with an output wheel engaged with the winding shaft; an electromagnetic brake which comprises an electromagnet and a brake disc and which is configured to brake the drive shaft of the electric motor when the electromagnet is electrically energized and to release the drive shaft of the electric motor when the electromagnet is electrically de-energized, wherein the electromagnet is disposed to surround the second end of the drive shaft and secured to a stator end cap of the electric motor, the stator end cap is secured to the tubular housing, the brake disc has an end surface facing the electromagnet, and the brake disc is provided on the drive shaft; and a control circuit which is electrically connected to both of the electric motor and the electromagnet and which is configured to electrically energize the electric motor while electrically de-energizing the electromagnet and to electrically energize the electromagnet while electrically de-energizing the electric motor.

The second end of the drive shaft of the electric motor is provided with an end disc. The brake disc is located between the electromagnet and the end disc. The brake disc is attached to the end disc via a reed. In the case that the electromagnet is electrically de-energized, the brake disc is biased away from the electromagnet by the reed.

Preferably, the cylinder type door operator comprises a centrifugal brake disposed to surround the first end of the drive shaft of the electric motor for limiting a rotational speed of the drive shaft within a safe range by means of friction caused by a centrifugal force exerted on an inner circumferential surface.

Preferably, the cylinder type door operator comprises a speed reduction mechanism comprising a first gear train. The drive shaft of the electric motor is coupled to the output shaft via the speed reduction mechanism which provides speed reduction from the drive shaft to the output shaft by means of the first gear train.

The cylinder type door operator further comprises a base secured to the second end of the tubular housing and an annular member pivotally fitted on the base and secured to the winding shaft. As such, the winding shaft is supported at two positions equally.

The annular member comprises an internal gear which is engaged with a sun gear provided on an external shaft through at least one planet gear. Additionally, the cylinder type door operator further comprises a stroke limiting module coupled to the external shaft via a second gear train. The stroke limiting module comprises a pair of sliders which are provided on a guide rod and displaceable axially along the guide rod and a plurality of limit switches which are arranged in a travel range of the sliders for defining an upper stop position and a lower stop position of the movable barrier.

Accordingly, with aid of the control circuit, the electromagnet is electrically energized when the electric motor is electrically de-energized so that the brake disc is attracted by the electromagnet and hence the drive shaft of the electric motor is braked; and the electric motor is electrically energized when the electromagnet is electrically de-energized so that the brake disc is biased away from the electromagnet by the reed and hence the drive shaft is released and rotated. The movable barrier is moved by using a potential energy so as to shut the door automatically when both of the electric motor and the electromagnet are electrically de-energized or when a power failure occurs.

### BRIEF DESCRIPTION OF THE DRAWINGS

FIG. 1 is an exploded view showing a cylinder type door operator of the present invention;

FIG. 2 is a cross-sectional view showing the cylinder type door operator of FIG. 1 in an assembled state;

FIG. 3 is a schematic view showing a first embodiment of the cylinder type door operator of the present invention, wherein a wingding shaft box is not shown and a winding shaft is partly cut out;

FIG. 4 is a schematic cross-sectional view taken along line 4-4 of FIG. 3;

FIG. 5 is a partly enlarged view showing a portion A of FIG. 4;

FIG. 6 is a partly enlarged view showing a portion B of FIG. 4;

FIG. 7 is a perspective view showing connection between the cylinder type door operator of the present invention and a stroke limiting module;

FIG. 8 is a block diagram of a control circuit according to an exemplary embodiment of the present invention;

FIG. 9 is a schematic view showing a second embodiment of the cylinder type door operator of the present invention in a state that the door is open, wherein the movable barrier is arranged to be moved horizontally in a horizontal plane;

FIG. 9a is a schematic view showing the second embodiment of the cylinder type door operator of the present invention in a state that the door is shut;

FIG. 10 is a schematic view showing a third embodiment of the cylinder type door operator of the present invention in a state that the door is open, wherein the movable barrier is arranged to be moved horizontally in a vertical plane; and

FIG. 10a is a schematic view showing the third embodiment of the cylinder type door operator of the present invention in a state that the door is shut.

### DESCRIPTION OF THE PREFERRED EMBODIMENTS

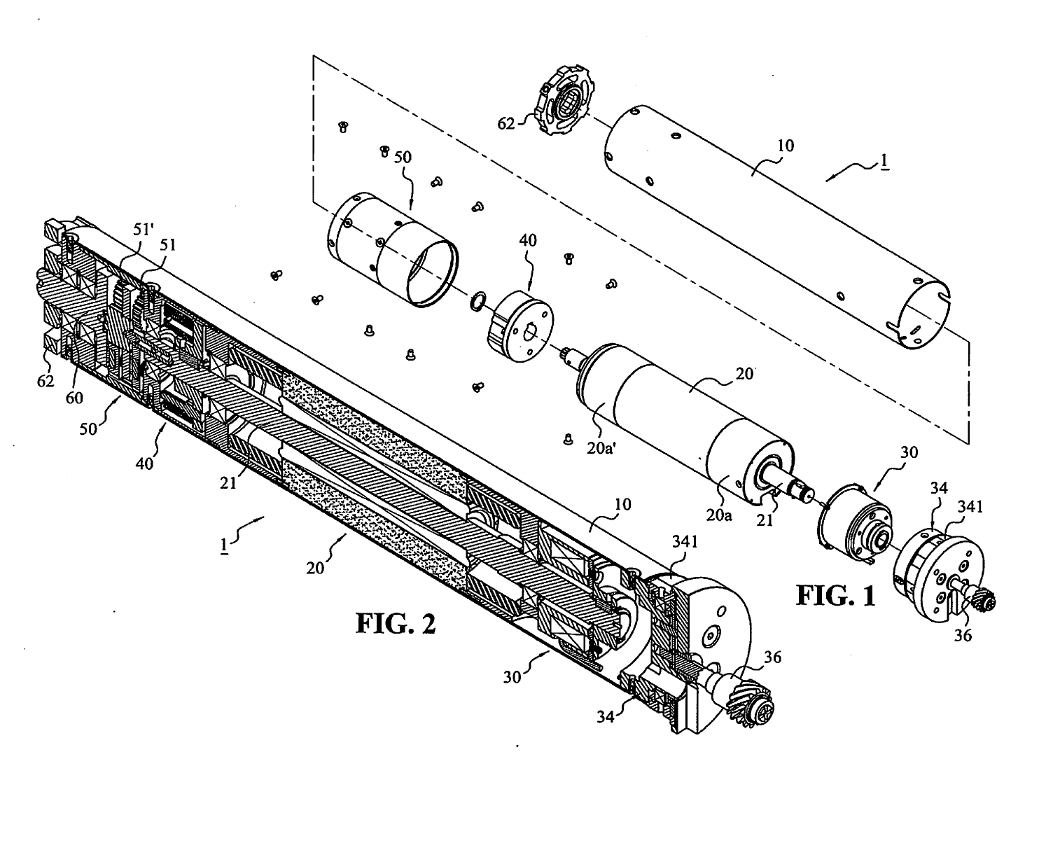

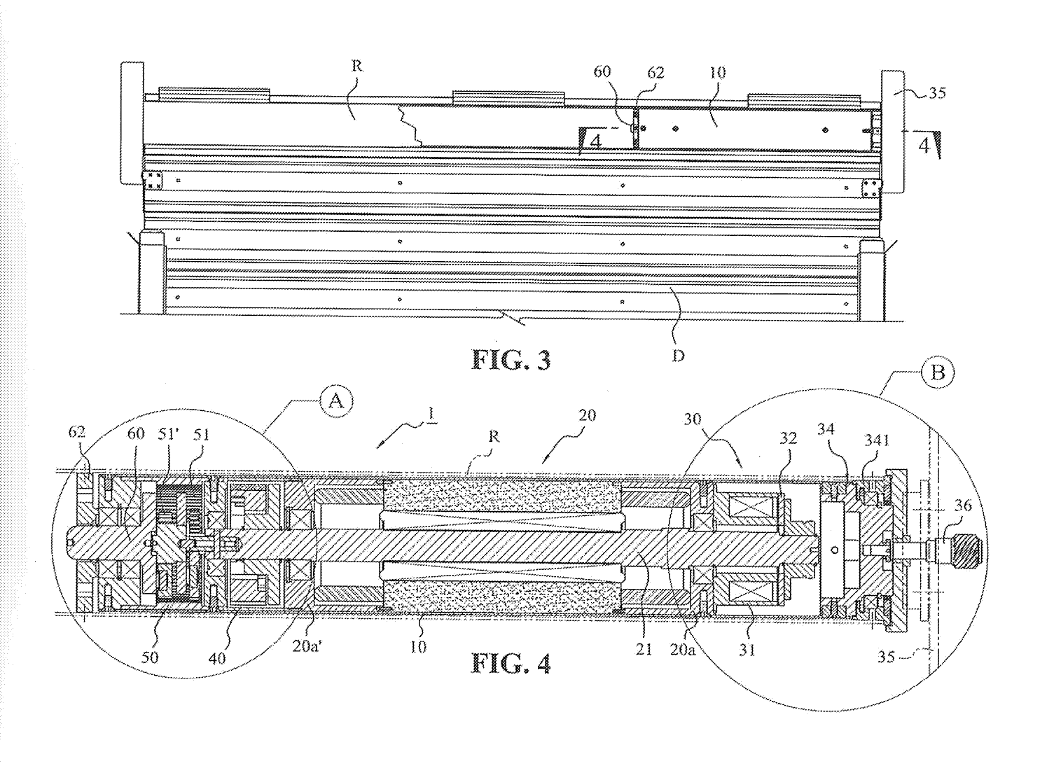

FIGS. 1, 2, 3, and 4 show a first embodiment of a cylinder type door operator of the present invention. The embodiment is illustrated by a door operator for a fire-proof or smoke-proof door in which a movable barrier is arranged to be moved vertically in a vertical plane, but the present invention is not limited to the fire-proof or smoke-proof door and can be applied to other types of doors in which a movable barrier is arranged to be moved horizontally in a horizontal plane or in a vertical plane. Generally, a hollow winding shaft R is pivotally provided in a winding shaft box (not shown) for upward or downward moving a movable barrier D as well known. Since the present invention is not intended to involve modifications to the connection of the winding shaft to the winding shaft box, the introduction of such connection is omitted. A cylinder type door operator 1 according to the present invention is disposed within the winding shaft R which is arranged in a horizontal direction. As shown in the figures, the door operator 1 comprises a tubular housing 10, an electric motor 20, an electromagnetic brake 30, a centrifugal brake 40, a speed reduction mechanism 50, and an output shaft 60.

With reference to FIGS. 1 to 4, the tubular housing 10 has an internal space. The tubular housing 10 comprises a first end inserted into the winding shaft R and a second end secured to the winding shaft box. An external diameter of the tubular housing 10 is slightly smaller than an internal diameter of the winding shaft R so that a proper gap is kept between the tubular housing 10 and the winding shaft R.

The electric motor 20 comprising a drive shaft 21 is accommodated in the internal space between the first end and the second end of the tubular housing 10. The electric motor 20 is secured to the tubular housing 10 via a pair of stator end caps 20a, 20a′. The drive shaft 21 has a first end oriented toward the first end of the tubular housing 10 and a second end oriented toward the second end of the tubular housing 10.

The centrifugal brake 40 is disposed to surround the first end of the drive shaft 21 of the electric motor 20. In the case that the rotation speed of the drive shaft 21 reaches or exceed a preset threshold, the centrifugal brake 40 functions to limit the rotation speed of the drive shaft 21 by means of friction caused by a centrifugal force exerted on an inner circumferential surface. The speed reduction mechanism 50 is coaxially connected to the first end of the drive shaft 21 of the electric motor 20. The speed reduction mechanism 50 comprises a plurality of gear trains 51, 51′. The speed reduction mechanism 50 provides speed reduction from the drive shaft 21 to the output shaft 60 so as to convert the rotation speed of the drive shaft 21 to a reduced rotation speed suitable for upward or downward moving the movable barrier. Therefore, the speed reduction ratio of the speed reduction mechanism 50 can be optionally set (the figures show that the gear trains are composed of an internal gear, a planet gear and a sun gear).

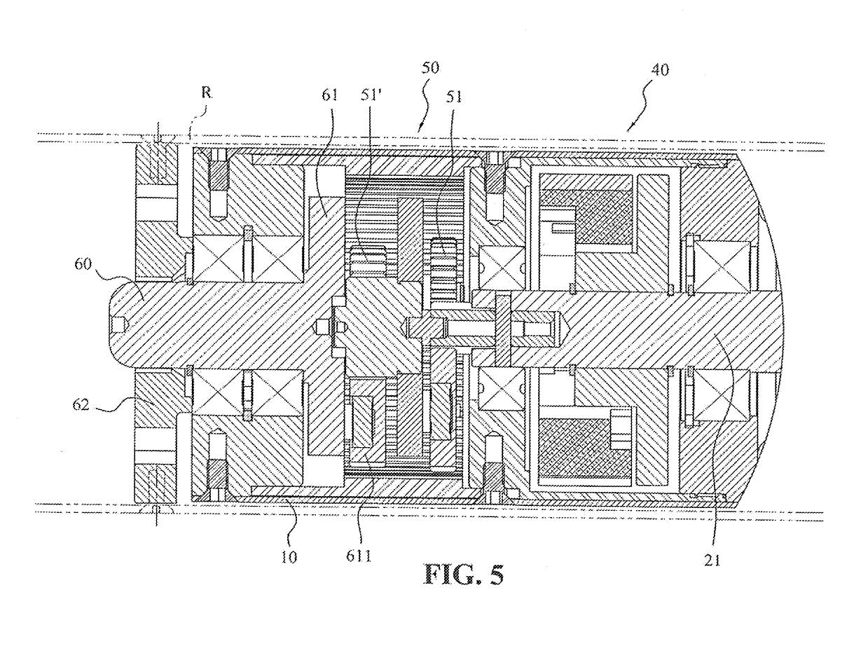

One end of the output shaft 60 comprises a flange 61 which is provided with a power gear 611 as clearly shown in FIG. 5. The drive shaft 21 is coupled to the power gear 611 through the speed reduction mechanism 50. The other end of the output shaft 60 is protruded out of the tubular housing 10 and provided with an output wheel 62 secured thereon. The outer circumferential profile of the output wheel 62 conforms to the inner circumferential profile of the winding shaft R so that the output wheel 62 can be fitted into and engaged with the winding shaft R. As such, a driving torque of the drive shaft 21 can be transmitted to the winding shaft R through the output wheel 62.

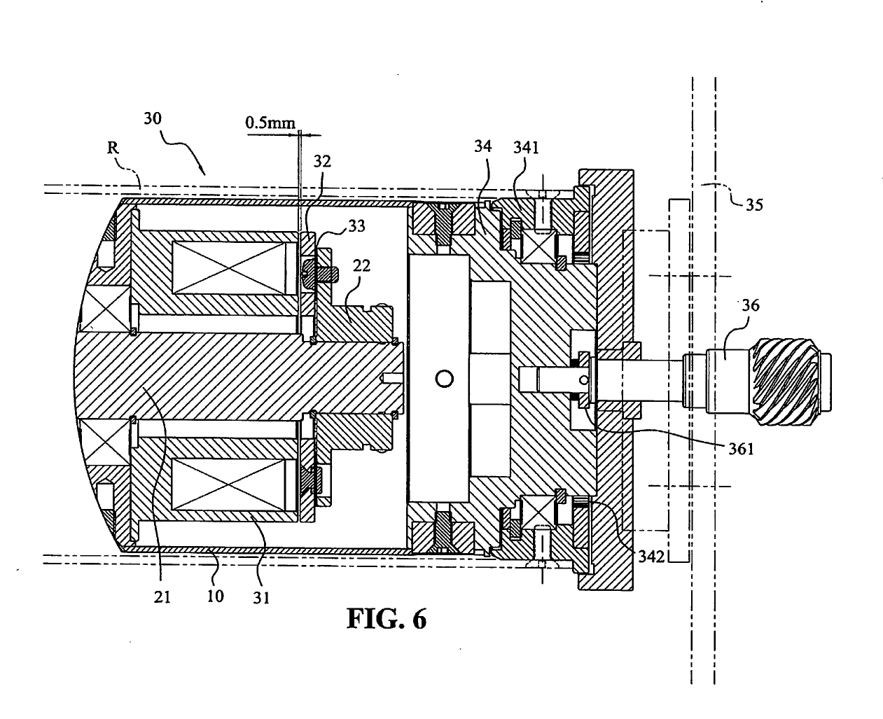

The electromagnetic brake 30 comprises an electromagnet 31 and a brake disc 32. The electromagnet 31 is disposed to surround the second end of the drive shaft 21. The electromagnet 31 is secured to the stator end cap 20a. The second end of the drive shaft 21 is provided with an end disc 22 secured thereon. The second end of the drive shaft 21 coaxially passes through the brake disc 32, and the brake disc 32 is disposed to be axially displaceable between the electromagnet 31 and the end disc 22. The brake disc 32 has an end surface facing the electromagnet 31. The electromagnetic brake 30 further comprises a reed 33 which is preloaded. The brake disc 32 is attached to the end disc 22 via this reed 33. The brake disc 32 is biased to the end disc 22 by the reed 33 in a free state (as shown in FIG. 6).

In detail, in the case that the electromagnet 31 is electrically energized, the brake disc 32 is attracted by the electromagnet 31 while the elastic potential energy of the reed 33 is increased. At this time, the electromagnetic brake 30 stops the drive shaft 21 from rotating. When the electromagnet 31 is electrically de-energized, the brake disc 32 is biased away from the electromagnet 31 by the reed 33 so as to release the drive shaft 21.

With reference to FIGS. 5 and 6, the door operator 1 according to the present invention further comprises a base 34 secured to the second end of the tubular housing 10; and an annular member 341 pivotally provided on the base 34. The base 34 is secured to the winding shaft box (not shown) via a plate member 35. The annular member 341 is secured to the winding shaft R. The winding shaft R is supported at two positions by the annular member 341 and the output wheel 62 of the door operator 1 such that the winding shaft R can be driven by the door operator 1 more smoothly. Further, the winding shaft R can be evenly supported, and the rigidity of the winding shaft R can be increased.

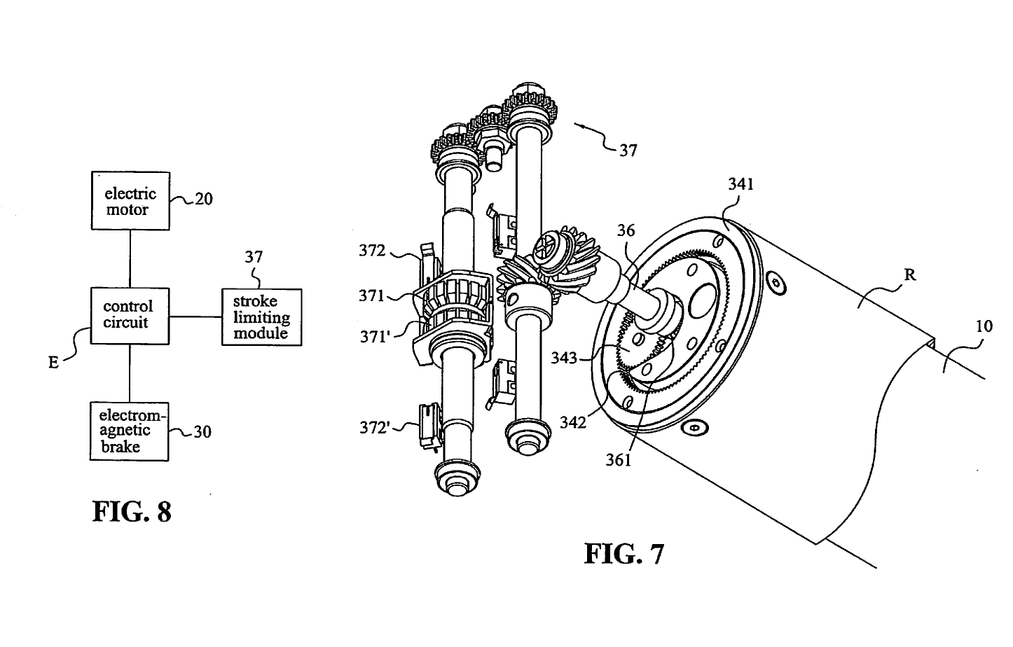

With reference to FIG. 6 and FIG. 7, the annular member 341 comprises an internal gear 342 which is engaged with a sun gear 361 provided on an external shaft 36 through at least one planet gear 343. FIG. 7 shows a stroke limiting module 37 located out of the winding shaft box. For convenience, the stroke limiting module is schematically shown in FIG. 7. The stroke limiting module 37 is coupled to the external shaft 36 via a second gear train. The stroke limiting module 37 comprises a pair of sliders 371, 371′ which are provided on a guide rod and displaceable axially along the guide rod and a plurality of limit switches 372, 372′ disposed in a travel range of the pair of sliders 371, 371′ for defining an upper stop position and a lower stop position of the movable barrier D.

According to the embodiment of the present invention, a control circuit E is electrically connected to the electric motor 20, the electromagnet 31, and the stroke limiting module 37, as shown in FIG. 8. The electromagnet 31 can be electrically energized for braking the drive shaft 21 of the electric motor 20. Generally, the door may be fully opened, partly opened, or completely shut under control. For a fire-proof or smoke-proof door, the door operator may be configured to shut the door automatically when a power failure such as interruption of power supply caused by an accident occurs.

Accordingly, in order to upward or downward move the movable barrier, the control circuit E is configured to electrically energize the electric motor 20 while electrically de-energizing the electromagnet 31 such that the brake disc 32 is biased away from the electromagnet 31 by the reed 33, and the drive shaft 21 is released by the electromagnetic brake 30 and rotated by the electric motor 20. As such, the output wheel 62, engaged with the winding shaft R, of the output shaft 60 is driven and rotated by the drive shaft 21 such that the movable barrier D is moved upward or downward. In order to brake the drive shaft 21 of the electric motor, the control circuit is also configured to electrically energize the electromagnet 31 while electrically de-energizing the electric motor 20 such that the brake disc 32 is attracted by the electromagnet 31. When both of the electric motor 20 and the electromagnet 31 are electrically de-energized or when a power failure such as interruption of power supply caused by an accident occurs, the drive shaft 21 of the electric motor 20 and hence the winding shaft R are released so that the movable barrier D is downward unwound due to the weight of the movable barrier to shut the door.

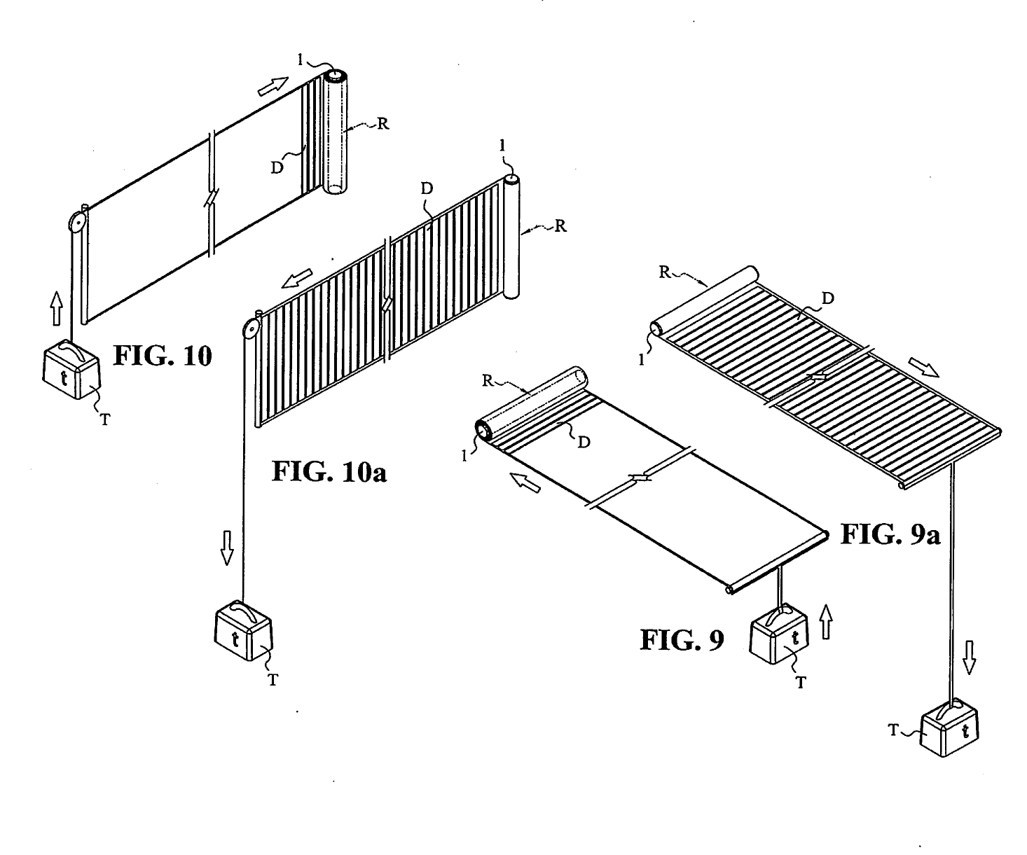

FIGS. 9 and 9a show a second embodiment of the cylinder type door operator according to the present invention. The second embodiment of the cylinder type door operator is different from the first embodiment in that in the second embodiment, the movable barrier D is arranged to be moved horizontally in a horizontal plane and loaded by a counterweight T. The counterweight T is arranged in such a manner that the gravitational potential energy of the counterweight T having a tendency to move the movable barrier to shut the door is stored or increased while the movable barrier is moved to open the door (as shown in FIG. 9). As such, the movable barrier D can be moved horizontally by using the gravitational potential energy of the counterweight T so as to shut the door automatically (as shown in FIG. 9a) when both of the electrical motor and the electromagnet are electrically de-energized or when a power failure occurs. In a modified embodiment (not shown), the movable barrier may be loaded by a spring. The spring is arranged in such a manner that the elastic potential energy of the spring having a tendency to move the movable barrier to shut the door is stored or increased while the movable barrier is moved to open the door.

FIGS. 10 and 10a show a third embodiment of the cylinder type door operator according to the present invention. The third embodiment of the cylinder type door operator is different from the second embodiment in that in the third embodiment, the movable barrier D is arranged to be moved horizontally in a vertical plane while the winding shaft R is arranged in a vertical direction. The movable barrier is loaded with the counterweight T. The counterweight T is arranged in such a manner that the gravitational potential energy of the counterweight T having a tendency to move the movable barrier to shut the door is stored or increased while the movable barrier is moved to open the door (as shown in FIG. 10). As such, the movable barrier D can be moved horizontally by using the gravitational potential energy of the counterweight T so as to shut the door automatically (as shown in FIG. 10a) when both of the electrical motor and the electromagnet are electrically de-energized or when a power failure occurs. In a modified embodiment (not shown), the movable barrier may be loaded by a spring. The spring is arranged in such a manner that the elastic potential energy of the spring having a tendency to move the movable barrier to shut the door is stored or increased while the movable barrier is moved to open the door.

It should be understood that the embodiment and the accompanying drawings have been described for illustrative purposes and the present invention is limited by the following claims. Further, those skilled in the art will appreciate that various modifications, additions and substitutions are allowed without departing from the scope and spirit of the invention according to the accompanying claims.

What is claimed is:

1. A cylinder type door operator disposed within a hollow winding shaft pivotally provided in a winding shaft box for moving a movable barrier, the door operator comprising:
a tubular housing having an internal space, the tubular housing comprising a first end inserted into the winding shaft and a second end secured to the winding shaft box;
an electric motor accommodated in the internal space of the tubular housing, the electric motor comprising a drive shaft having a first end and a second end;
an output shaft one end of which is coupled to the first end of the drive shaft and the other end of which is protruded out of the tubular housing and provided with an output wheel engaged with the winding shaft;
an electromagnetic brake which comprises an electromagnet and a brake disc and which is configured to brake the drive shaft of the electric motor when the electromagnet is electrically energized and to release the drive shaft of the electric motor when the electromagnet is electrically de-energized, wherein the electromagnet is disposed to surround the second end of the drive shaft and secured to the tubular housing, and the brake disc has an end surface facing the electromagnet and is provided on the drive shaft; and
a control circuit which is electrically connected to both of the electric motor and the electromagnet and which is configured to electrically energize the electric motor while electrically de-energizing the electromagnet and to electrically energize the electromagnet while electrically de-energizing the electric motor so that the drive shaft of the electric motor is braked when the electric motor is electrically de-energized, the drive shaft is released when the electric motor is electrically energized, and the movable barrier is moved by using potential energy, which is stored or increased while the movable barrier is moved to open a door, so as to shut the door automatically when both of the electrical motor and the electromagnet are electrically de-energized or when a power failure occurs.

2. The cylinder type door operator of claim 1, further comprising: a base secured to the second end of the tubular housing; and an annular member pivotally fitted on the base and secured to the winding shaft.

3. The cylinder type door operator of claim 1, wherein the second end of the drive shaft of the electric motor is provided with an end disc, the brake disc is located between the electromagnet and the end disc, and the brake disc is attached to the end disc via a reed.

4. The cylinder type door operator of claim 1, further comprising a centrifugal brake disposed to surround the first end of the drive shaft of the electric motor for limiting a rotation speed of the drive shaft within a safe range.

5. The cylinder type door operator of claim 1, further comprising a speed reduction mechanism comprising a first gear train, wherein the drive shaft of the electric motor is couple to the output shaft via the speed reduction mechanism which provides speed reduction from the drive shaft to the output shaft by the first gear train.

6. The cylinder type door operator of claim 2, wherein the annular member comprises an internal gear which is engaged with a sun gear provided on an external shaft via at least one planet gear.

7. The cylinder type door operator of claim 6, further comprising a stroke limiting module which is linked to the external shaft via a second gear train and which comprises a pair of sliders and a plurality of limit switches, wherein the pair of sliders are provided on a guide rod and displaceable axially along the guide rod, and the limit switches are disposed in a travel range of the pair of sliders for defining an upper stop position and a lower stop position of the movable barrier.

8. The cylinder type door operator of claim 1, wherein the movable barrier is arranged to be moved vertically in a vertical plane while the winding shaft into which the door operator is integrated is arranged in a horizontal direction,
a gravitational potential energy of the movable barrier is stored or increased while the movable barrier is moved to open the door; and
the movable barrier is moved by using the gravitational potential energy of the movable barrier to shut the door automatically when both of the electrical motor and the electromagnet are electrically de-energized or when the power failure occurs.

9. The cylinder type door operator of claim 1, wherein the movable barrier is arranged to be moved horizontally in a horizontal plane while the winding shaft into which the door operator is integrated is arranged in a horizontal direction,
the movable barrier is loaded by a counterweight or a spring,
the counterweight or the spring is arranged in such a manner that a gravitational potential energy of the counterweight or an elastic potential energy of the spring is stored or increased while the movable barrier is moved to open the door; and
the movable barrier is moved by using the gravitational potential energy or the elastic potential energy to shut the door automatically when both of the electrical motor and the electromagnet are electrically de-energized or when the power failure occurs.

10. The cylinder type door operator of claim 1, wherein the movable barrier is arranged to be moved horizontally in a vertical plane while the winding shaft into which the door operator is integrated is arranged in a vertical direction,
the movable barrier is loaded by a counterweight or a spring,
the counterweight or the spring is arranged in such a manner that a gravitational potential energy of the counterweight or an elastic potential energy of the spring is stored or increased while the movable barrier is moved to open the door; and
the movable barrier is moved by using the gravitational potential energy or the elastic potential energy to shut the door automatically when both of the electrical motor and the electromagnet are electrically de-energized or when the power failure occurs.
